(19) United States
(12) Patent Application Publication
(10) Pub. No.: US 2014/0340431 A1
(43) Pub. Date: Nov. 20, 2014

(54) CONTROL UNIT, DISPLAY DEVICE INCLUDING CONTROL UNIT, AND CONTROL METHOD

(71) Applicant: Sharp Kabushiki Kaisha, Osaka-shi, Osaka (JP)

(72) Inventor: Ryo Yamakawa, Osaka-shi (JP)

(73) Assignee: SHARP KABUSHIKI KAISHA a corporation

(21) Appl. No.: 14/360,957

(22) PCT Filed: Nov. 28, 2012
(86) PCT No.: PCT/JP2012/080689

§ 371 Date: May 28, 2014

(30) Foreign Application Priority Data
Nov. 30, 2011 (JP) 2011-261988

(51) Int. Cl. G09G 3/20

(52) U.S. Cl. CPC G09G 3/2003; G09G 2320/0242; G09G 2320/0276
USPC 345/690

(57) ABSTRACT

A control unit (16) is provided in a display device having a plurality of pixels and controls a display signal indicating gradation of the pixels. The control unit (16) includes a gradation correction portion (16b) that determines correction values for gradation values of each of the pixels indicated by the display signal in accordance with a drive frequency of the pixels.

### TECHNICAL FIELD

The present invention relates to a technology for controlling a signal indicating the gradation of a plurality of pixels in a display device.

### BACKGROUND ART

In recent years, flat panel display devices including, e.g., liquid crystal display devices have been widely used as display portions of electrical products such as a computer and a television.

These display devices generally include a display screen in which a large number of pixels are arranged in a matrix, and images are sequentially displayed on the display screen based on an input clock signal and an image signal that is synchronized with the clock signal. The pixels arranged in a matrix in the display screen are connected to many gate lines and many source lines that are similarly arranged in rows and columns in this display screen. When a gate voltage is applied to the gate lines, a row of pixels connected to each of these gate lines are selected, and a source voltage is applied to the selected pixels via the source lines. The frequency of the clock signal is an example of a drive frequency of the display device.

In order to suppress electromagnetic interference (EMI) caused by radiated electromagnetic waves in the above display devices, a spread spectrum (SS) technology has been used, which intentionally changes the frequency of the clock signal. In the spread spectrum technology, the frequency of the clock signal is changed periodically and continuously, thereby spreading the spectrum of the radiated electromagnetic waves so that the peak of the spectrum is reduced.

On the other hand, a technology for increasing the drive frequency of a liquid crystal (e.g., to 240 Hz or the like) has been recently adopted so as to be compatible with 3D displays or to improve the dynamic image performance of the liquid crystal. In such a case, the write time is varied because of the spread spectrum (SS), which leads to small variations in the charging rate of the liquid crystal. This may result in non-uniform brightness of the liquid crystal. When the drive frequency is changed by the spread spectrum, the write time at which the gate voltage is high and the TFT is turned ON is varied for each pixel (e.g., for each horizontal line). If the drive frequency is relatively slow, a sufficiently long write time can be set. However, in the case of high-speed driving, the amount of charge stored in the liquid crystal capacitance is varied. In other words, if the drive frequency is high, it is more likely that the brightness will be reduced due to a lack of charge. Consequently, a brightness difference occurs between each of the horizontal lines of the screen. A specific example of this will be described with reference to FIG. 12.

FIGS. 12A to 12D are timing charts showing an operation of a pixel in a display device when the drive frequency is relatively low. FIGS. 12E to 12H are timing charts when the drive frequency is higher than that shown in FIGS. 12A to 12D.

In a pixel P of the display device, as shown in FIG. 12A, when a gate clock GCK is turned ON at a time T1 (FIG. 12B), a gate driver supplies a scanning signal Gout ge to a gate line (FIG. 12C). Subsequently, when a control signal LS for a source driver is turned ON at a time T2, the source driver supplies a gradation signal (gradation voltage) Sout se to the corresponding source line (FIG. 12D). Thus, in the pixel P, the charge of the gradation voltage starts from the time T2.

Then, when the gate clock GCK is turned ON at a time T3, the supply of the scanning signal Gout ge to the corresponding gate line is stopped (FIG. 12C). Next, the control signal LS for the source driver is turned ON at a time T4, and the supply of the gradation signal Sout se to the corresponding source line is stopped (FIG. 12D). Thus, in the pixel P, the charge of the gradation voltage stops at the time T3. Accordingly, the charging period of the gradation voltage in the pixel P is between the time T2 and the time T3.

On the other hand, when the drive frequency is higher than that shown in FIGS. 12A to 12D, the period of the gate clock GCK is between the time T1 and a time T5, as shown in FIG. 12E, and is shorter than the period shown in FIG. 12A. The period of the control signal LS for the source driver is between the time T2 and a time T6, and is also shorter than the period shown in FIG. 12B. Consequently, the charging period is between the time T2 and the time T5, which is shorter than the charging period shown in FIGS. 12A to 12D by L. As described above, when the drive frequency is high, the brightness is likely to be reduced due to a lack of charge. For example, if the charging period is short, and the amount of charge to be stored is varied due to fluctuations in the drive frequency, a difference in the amount of charge is likely to appear as a brightness difference on the display screen.

In order to suppress the occurrence of such a display failure due to the spread spectrum, there has been a conventional technology that synchronizes a fluctuation period of the frequency of the spread spectrum clock with the horizontal scanning period (see, e.g., Patent Document 1). This technology can deal with the EMI by the spread spectrum and also can suppress the occurrence of a display failure.

### PRIOR ART DOCUMENTS

### Patent Documents

Patent Document 1: JP 2008-216606 A

### DISCLOSURE OF INVENTION

### Problem to be Solved by the Invention

In the above conventional technology, however, a timing controller needs to be designed in accordance with the spread spectrum, so that it is difficult to change the frequency of the spread spectrum flexibly. Therefore, the use of the conventional technology may be difficult to suppress a display failure due to fluctuations in the drive frequency.

With the foregoing in mind, it is an object of the present invention to suppress non-uniform brightness due to fluctuations in the drive frequency by a method different from the conventional technology.

### Means for Solving Problem

A control unit of the present invention is provided in a display device having a plurality of pixels and controls a display signal indicating gradation of the pixels. The control unit includes a gradation correction portion that determines correction values for gradation values of each of the pixels indicated by the display signal in accordance with a drive frequency of the pixels.

The control unit determines the correction values for the gradation values of each of the pixels indicated by the display signal in accordance with the drive frequency, and therefore can correct the gradation values in accordance with the drive frequency. Thus, the control unit can suppress variations in the brightness due to fluctuations in the drive frequency by correcting the gradation values of the display signal.

The control unit may have an aspect in which the gradation correction portion determines the correction values for the gradation values of each of the pixels in a first display region of the display device and the correction values for the gradation values of each of the pixels in a second display region of the display device, and the drive frequency of the pixels in the first display region differs from the drive frequency of the pixels in the second display region.

In the above configuration, the gradation correction portion can determine the correction values independently for each of the first display region and the second display region that differ in the drive frequency. Therefore, the gradation values can be appropriately corrected in accordance with the drive frequency in the respective display regions.

In the control unit, the gradation correction portion may determine the correction values for the pixels in the first display region by referring to first correction data that has been previously stored and indicates a first amount of correction for the gradation values, and the gradation correction portion may determine the correction values for the pixels in the second display region by referring to second correction data that has been previously stored and indicates a second amount of correction for the gradation values.

In the above configuration, the gradation correction portion determines the correction values for the gradation values by using different correction data (i.e., the first correction data and the second correction data) for each of the first display region and the second display region that differ in the drive frequency. Therefore, the gradation values can be appropriately corrected in accordance with the drive frequency in the respective display regions.

The control unit may have an aspect in which the gradation correction portion includes an operation portion that determines the correction values by performing an operation using the gradation values of each of the pixels contained in the display signal, and the operation portion performs a first operation to determine the correction values for the gradation values of the pixels in the first display region and a second operation to determine the correction values for the gradation values of the pixels in the second display region.

In the above configuration, the gradation correction portion calculates the correction values for the gradation values by performing different operations (i.e., the first operation and the second operation) for each of the first display region and the second display region that differ in the drive frequency. Therefore, the gradation values can be appropriately corrected in accordance with the drive frequency in the respective display regions.

The control unit may have an aspect in which the display device has scanning lines provided for each line of the pixels that are arranged in a matrix, the drive frequency of the pixels is controlled line by line with a scanning signal input to the scanning lines, and a fluctuation range of the drive frequency of the scanning lines in the first display region differs from a fluctuation range of the drive frequency of the scanning lines in the second display region.

In the above configuration, the drive frequency is controlled for each of the scanning lines, and the fluctuation range of the drive frequency of the scanning lines in the first region differs from the fluctuation range of the drive frequency of the scanning lines in the second region. Therefore, the gradation values can be appropriately corrected line by line in accordance with the drive frequency. This can make the control easy.

In the control unit, the drive frequency may fluctuate at a predetermined fluctuation period Ts, and a value obtained by multiplying one-half the fluctuation period Ts by N (N is a natural number) may be a scanning period Tv of all the scanning lines.

In the above configuration, the value obtained by multiplying one-half the fluctuation period Ts of the drive frequency by N is the scanning period Tv. Therefore, the distribution of the drive frequency of all the scanning lines in the display region becomes constant (when N is an even number) or is reversed at the scanning period Tv (when N is an odd number). Thus, the first display region and the second display region can be made uniform. Consequently, a process of determining the correction values for the gradation values of the pixels can be simplified.

In the control unit, the gradation correction portion may acquire a signal for controlling the drive frequency of the pixels, use the signal to decide a time period during which the drive frequency is higher than that before and after the time period and/or a time period during which the drive frequency is lower than that before and after the time period, and determine the correction values for the gradation values of each of the pixels indicated by the display signal for each time period thus decided.

In the above configuration, since the signal for controlling the drive frequency is used to determine the correction values for the gradation values of each of the pixels, the gradation values can be appropriately corrected in accordance with the drive frequency.

The control unit may have an aspect in which the display device has scanning lines provided for each line of the pixels that are arranged in a matrix, the drive frequency of the pixels is controlled line by line with a scanning signal input to the scanning lines, and the gradation correction portion acquires the scanning signal as a signal for controlling the drive frequency of the pixels, and determines the correction values for the gradation values of the pixels line by line in accordance with the drive frequency for each line.

In the above configuration, the drive frequency is controlled for each of the scanning lines, and the correction values are determined in accordance with the drive frequency of the scanning lines. Therefore, the gradation values can be appropriately corrected line by line in accordance with the drive frequency.

In the control unit, the gradation correction portion may determine the correction values by performing an operation or referring to correction data that has been previously stored and indicates an amount of correction for the gradation values.

The present invention also includes a display panel or a display device including the above control unit. In this case, the display panel or the display device with excellent display quality can be easily formed. The display device may be, e.g., a liquid crystal display device including a liquid crystal panel. Moreover, the present invention also includes a liquid crystal panel including the above control unit. The liquid crystal panel includes, e.g., a gate driver and a source driver that is located at a different position from the gate driver. The source driver receives a gradation voltage indicating the gradation values that have been corrected in accordance with the drive frequency from the gradation correction portion.

### Effects of the Invention

The present invention can suppress non-uniform brightness due to fluctuations in the drive frequency.

### BRIEF DESCRIPTION OF DRAWINGS

FIG. 1 is a diagram for explaining a liquid crystal display device of Embodiment 1 of the present invention.

FIG. 2 is a diagram for explaining the main configuration of a liquid crystal panel shown in FIG. 1.

FIG. 3 is a functional block diagram showing a configuration example of a control unit shown in FIG. 2.

FIG. 4 is a diagram for explaining a display area of a liquid crystal panel.

FIGS. 5A and 5B are graphs for explaining specific examples of correction values that are determined by a gradation correction portion with respect to different display areas, respectively.

FIG. 6 is a functional block diagram showing a configuration example of a control unit of Embodiment 2.

FIG. 7 is a functional block diagram showing the configuration of a control unit of a first modified example.

FIG. 8 is a diagram showing an example in which the setting of display areas in a display screen and the way that the frequency fluctuates are altered.

FIG. 9 is a diagram showing an example in which the setting of display areas in a display screen is altered.

FIG. 10 is a diagram showing another example in which the setting of display areas in a display screen and the way that the frequency fluctuates are altered.

FIG. 11 is a functional block diagram showing a configuration example of a control unit of Embodiment 3.

FIGS. 12A to 12H are timing charts showing an operation example of a pixel in a liquid crystal panel.

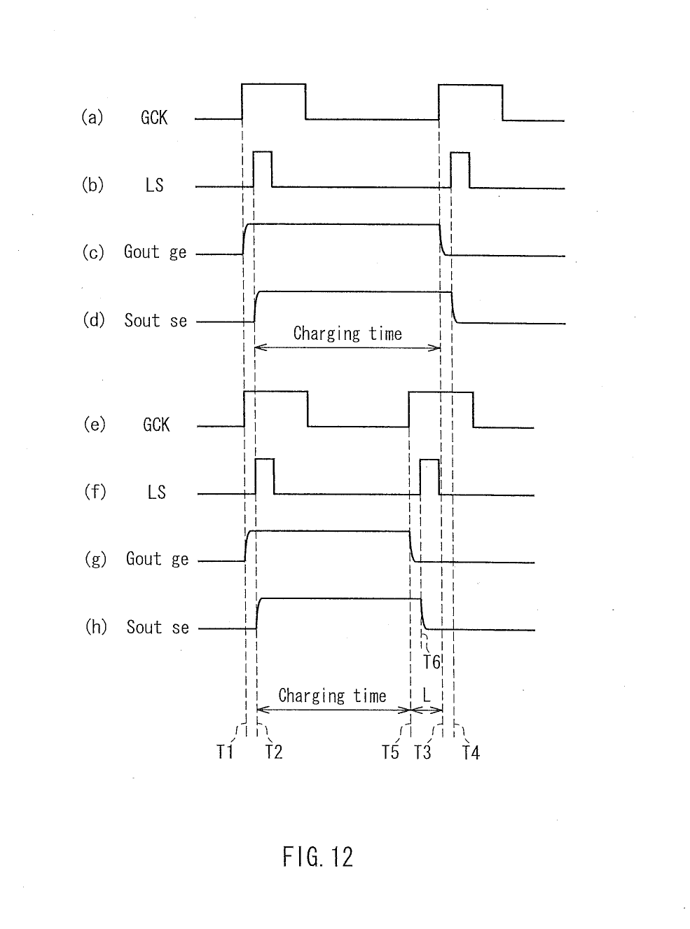

### DESCRIPTION OF THE INVENTION

Hereinafter, preferred embodiments of a display device of the present invention will be described with reference to the drawings. In the following description, the present invention is applied to a transmission type liquid crystal display device. The size and size ratio of each of the constituent members in the drawings do not exactly reflect those of the actual constituent members.

### Embodiment 1

### Configuration Example of Liquid Crystal Display Device

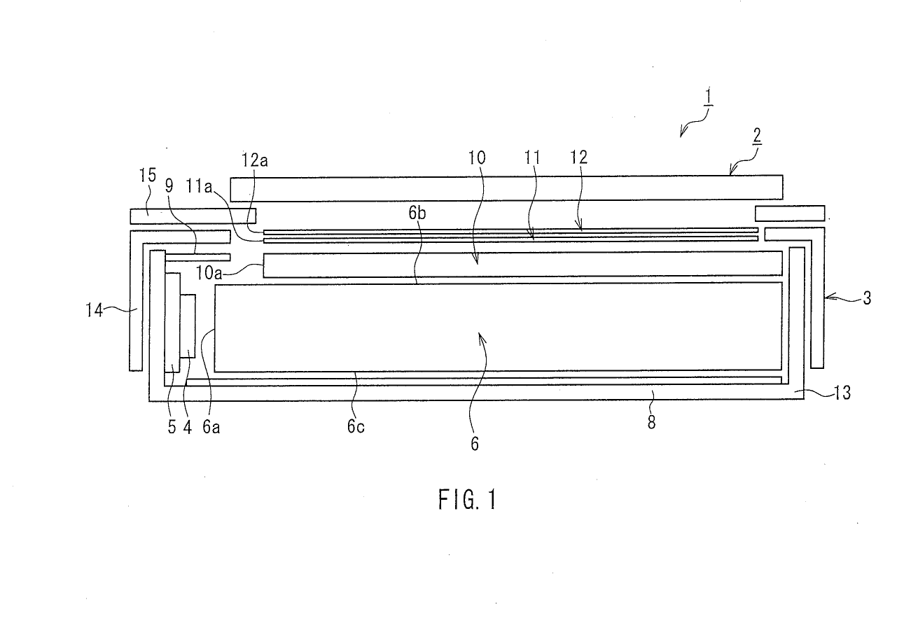

FIG. 1 is a diagram for explaining a liquid crystal display device of Embodiment 1 of the present invention. In FIG. 1, a liquid crystal display device 1 of this embodiment includes a liquid crystal panel (display portion) 2 for displaying information and a backlight device (backlight portion) 3. In the liquid crystal display device 1, the liquid crystal panel 2 uses illumination light from the backlight device 3 to display information. The liquid crystal panel 2 and the backlight device 3 are integrated into the transmission type liquid crystal display device 1.

The liquid crystal panel 2 includes a liquid crystal layer, and an active matrix substrate and a color filter substrate that are a pair of substrates sandwiching the liquid crystal layer (not shown). As will be described in detail later, pixel electrodes, thin film transistors (TFTs), or the like are formed between the active matrix substrate and the liquid crystal layer so as to correspond to a plurality of pixels included in a display surface of the liquid crystal panel 2. On the other hand, color filters, common electrodes, or the like are formed between the color filter substrate and the liquid crystal layer (not shown).

Moreover, the liquid crystal panel 2 includes a control device (not shown) that performs drive control of the liquid crystal panel 2 so that the liquid crystal layer is operated on a pixel-by-pixel basis, and thus the display surface is driven on a pixel-by-pixel basis, thereby displaying a desired image on the display surface.

The liquid crystal panel 2 of this embodiment may be, e.g., a normally black mode. Therefore, the liquid crystal panel 2 of this embodiment is configured so that when no voltage is applied to the liquid crystal layer, black display is performed, and the transmittance of light through the liquid crystal layer is increased with the voltage to be applied.

The backlight device 3 includes light emitting diodes (light sources) 4, an LED substrate (light source substrate) 5 on which the light emitting diodes 4 are mounted, and a light guide plate 6 that directs light from the light emitting diodes 4 in a predetermined propagation direction (i.e., the lateral direction of FIG. 1) and emits the light to the liquid crystal panel (object to be irradiated) 2. The light guide plate 6 may be made of; e.g., a transparent synthetic resin such as an acrylic resin having a rectangular cross section. The light guide plate 6 is located facing the light emitting diodes 4. The light guide plate 6 includes a light incident surface 6a for receiving light from the light emitting diodes 4, a light emission surface 6b from which the light is emitted to the liquid crystal panel 2, and an opposite surface 6c that is opposite to the light emission surface 6b.

The backlight device 3 also includes reflecting plates 8, 9. The reflecting plate 8 is provided under the light emitting diodes 4 and the light guide plate 6, and reflects light from the light emitting diodes 4 and the light guide plate 6. The reflecting plate 9 is provided on the side of the light emitting diodes 4 that faces the liquid crystal panel 2, and serves as a reflecting portion of light from the light emitting diodes 4. As optical members provided between the light guide plate 6 and the liquid crystal panel 2, e.g., a diffusing sheet 10, a prism sheet 11, and a reflection type polarizing plate 12 are disposed in this order from the light guide plate 6 side. These optical members can convert the light that has been emitted from the light emission surface 6b of the light guide plate 6 into planar illumination light with uniform brightness, and then provide the illumination light to the liquid crystal panel 2.

The backlight device 3 further includes a chassis 13 with a bottom and a bezel 14. The chassis 13 houses the light emitting diodes 4, the light guide plate 6, the diffusing sheet 10, the prism sheet 11, and the reflection type polarizing sheet 12. The bezel 14 is put over the chassis 13, i.e., covers it from the liquid crystal panel 2 side. The bezel 14 is a frame body having an L-shaped cross section and an opening. The chassis 13 and the bezel 14 can form an outer container of the backlight device 3. In the example shown in FIG. 1, a P (plastic) chassis 15 is placed on the bezel 14, and the liquid crystal panel 2 is mounted on the P chassis 15. Thus, the liquid crystal panel 2 and the backlight device 3 are jointed together.

Other than the above description, a silver or white coating with high light reflectance may be applied to the bottom of the chassis 13 that faces the light emitting diodes 4 and the light guide plate 6, and this bottom of the chassis 13 may be used instead of the reflecting plate 8 to reflect light from the light emitting diodes 4 and light from the light guide plate 6.

(Configuration Example of Liquid Crystal Panel)

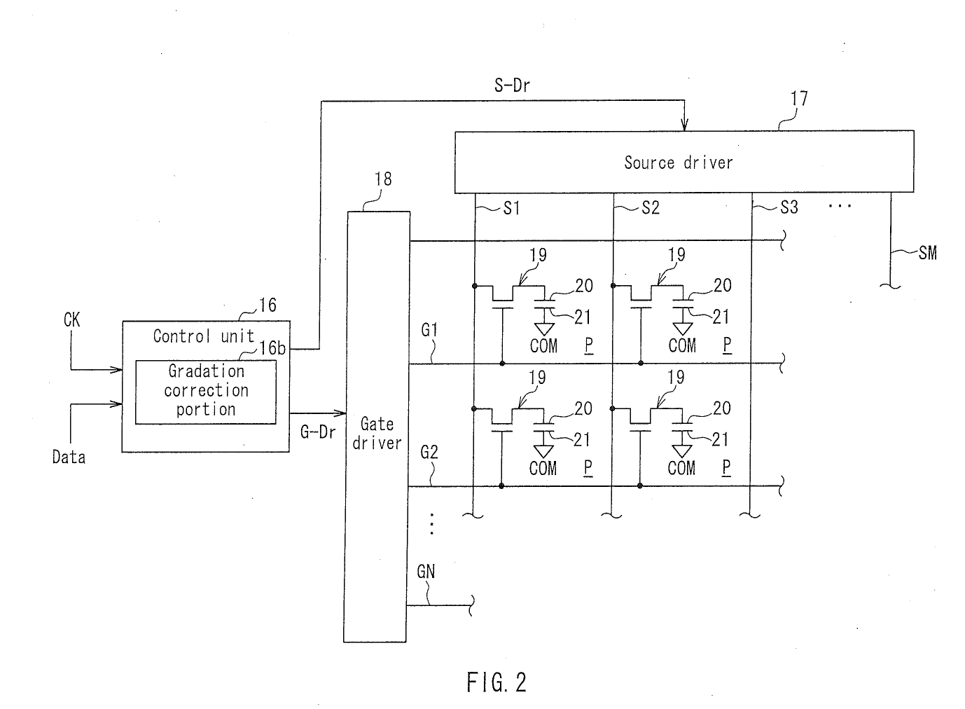

Next, the liquid crystal panel 2 of this embodiment will be described in detail with reference to FIGS. 2 to 4.

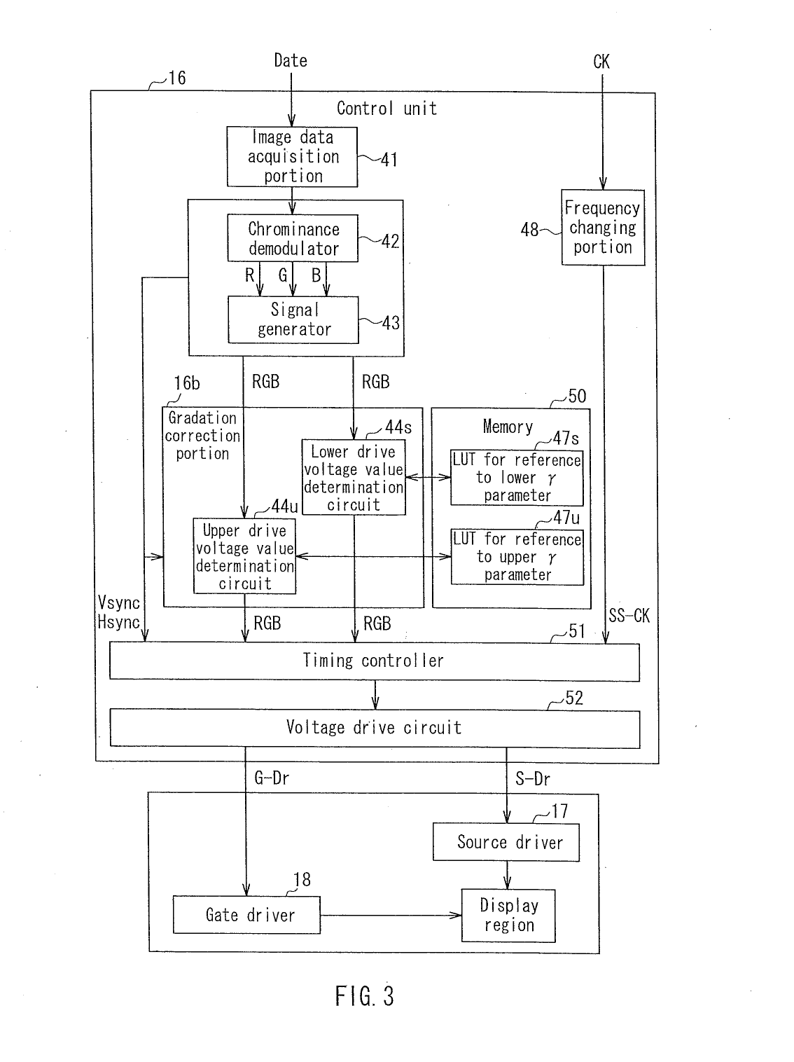

FIG. 2 is a diagram for explaining the main configuration of the liquid crystal panel 2 shown in FIG. 1. FIG. 3 is a block diagram showing a configuration example of a control unit shown in FIG. 2.

In the example shown in FIG. 2, the liquid crystal panel 2 has gate lines G1 to GN (N is an integer of 2 or more, and the gate lines are generically called “G” in the following) and source lines S1 to SM (M is an integer of 2 or more, and the source lines are generically called “S” in the following). The gate lines G and the source lines S extend along rows and columns of pixels P arranged in a matrix, respectively. The gate lines G and the source lines S are provided in two directions that intersect each other, and the pixels P are provided so as to correspond to each of the intersections of the gate lines G and the source lines S. In this embodiment, the gate lines G are arranged along the horizontal direction of the display screen, and the source lines S are arranged along the direction perpendicular to the gate lines G (i.e., the perpendicular direction).

A source driver 17 and a gate driver 18 are drive circuits for driving the pixels P of the liquid crystal panel 2 on a pixel-by-pixel basis. The source lines S and the gate lines G are connected to the source driver 17 and the gate driver 18, respectively. The pixels P are formed in the areas that are arranged in a matrix and separated from one another by the source lines S and the gate lines G. The pixels P may include red, green, and blue pixels. The red, green, and blue pixels P may be successively arranged, e.g., in this order in the direction parallel to the gate lines G1 to GN.

Based on an instruction signal (gate signal G-Dr) from a control unit 16, the gate driver 18 applies a gate voltage in sequence to the gate lines G so that gates of the corresponding switching elements 19 are turned ON. On the other hand, based on an instruction signal (source signal S-Dr) from the control unit 16, the source driver 17 outputs a gradation signal (gradation voltage) in response to the brightness (gradation) of the display image to the corresponding source lines S. The gate lines G are an example of scanning lines, and the gate signal is an example of a scanning signal.

The pixels P are connected to the gate lines G and the source lines S. When the gate voltage is applied (i.e., the gate signal is input) to the gate lines G, a row of pixels connected to each of these gate lines are selected. Then, a source voltage (gradation voltage) is applied (i.e., the gradation signal is input) to the selected pixels via the source lines.

Specifically, the gates of the switching elements 19, which are provided for each of the pixels P, are connected to the individual gate lines G. On the other hand, sources of the switching elements 19 are connected to the individual source lines S. Moreover, pixel electrodes 20, which are provided for each of the pixels P, are connected to drains of the switching elements 19. Each of the pixels P includes a common electrode 21 that is located opposite the pixel electrode 20 with the liquid crystal layer of the liquid crystal panel 2 interposed between them.

In this configuration, when the gate voltage is high, the gates of the switching elements 19 are turned ON, and then the source voltage is applied to the pixel electrodes 20 to change the voltages of the pixel electrodes 20, so that the liquid crystal capacitances, each of which is composed of the common electrode 21 and the pixel electrode 20 sandwiching the liquid crystal layer, are charged.

(Control Unit)

The control unit 16 includes a control circuit that controls the source driver 17 and the gate driver 18 based on a reference clock signal CK and a video signal Data that are input externally. Although not shown in the drawings, the control unit 16 may include a backlight control portion that performs drive control of the backlight device 3 using the input video signal Data.

The control unit 16 can be constituted, e.g., with one or more than one ASIC (application specific integrated circuit). The control unit 16 preferably includes a frame memory that is capable of storing display data contained in the video signal on frame-by-frame basis. The control unit 16 can perform a predetermined operation at a high speed on the display data that is sequentially stored in the frame memory. The control unit 16 may be formed by either a plurality of chips or circuits or a single integrated circuit.

The reference clock signal CK and the video signal Data are externally input to the control unit 16. For example, the video signal Data is input from the outside of the liquid crystal display device 1 via signal sources (not shown) such as a TV (television set) and a PC. The control unit 16 changes the frequency of the input reference clock signal CK continuously at a predetermined fluctuation period, and generates a spread spectrum clock signal SS-CK. Moreover, the control unit 16 controls timing with this spread spectrum clock signal SS-CK, and generates a gate signal G-Dr and a source signal S-Dr based on the input video signal Data. Thus, the drive frequency of the pixels in the liquid crystal panel 2 can be changed at a predetermined fluctuation period.

The control unit 16 includes a gradation correction portion 16b. The gradation correction portion 16b corrects gradation values of the pixels indicated by the source signal S-Dr in accordance with the drive frequency that fluctuates at a predetermined period (as will be described in detail later). For example, the source signal S-Dr generated by the control unit 16 can be corrected by the gradation correction portion 16b, and then output to the source driver 17.

The control unit 16 provides the gate signal G-Dr to the gate driver 18 and the source signal S-Dr to the source driver 17. The gate driver 18 and the source driver 17 apply a gate voltage Vg and a source voltage Vs to the gate lines G and the source lines S at the timing set by the gate signal G-Dr and the source signal S-Dr, respectively, so that the pixels P are driven.

With the above configuration, the control unit 16 can apply different gradation corrections to different drive frequencies. The purpose of correcting the gradation values by the gradation correction portion 16b is to make the actual brightness, which will be achieved by each of the pixels based on the gradation values of the source signal, closer to the desired value. For example, the gradation correction portion 16b may correct the gradation either by referring to correction data that indicates the amount of correction for the gradation values or by performing an operation with the use of a function representing the relationship between the gradation values and the correction values. The correction data may be, e.g., a look-up table that stores the gradation values in correspondence with the correction values, and there is no limitation to the data format. For example, the gradation can be corrected in accordance with the drive frequency by referring to different correction data or performing different operations with respect to a plurality of regions of a display region that differ in the drive frequency. Alternatively, the gradation can be corrected in accordance with the drive frequency by monitoring the drive frequency and switching the correction data to be referred to or the operation method in accordance with the drive frequency.

An example of the correction performed by the gradation correction portion 16b may be a gamma correction (γ correction). In the gamma correction, e.g., the gradation correction portion 16b can gamma-correct the gradation values of the source signal using gamma parameters (γ parameters) that differ according to fluctuations in the drive frequency. For example, the gamma correction can be performed by dividing the display region into a plurality of regions that differ in the drive frequency, and using different gamma parameters for each of the regions. Alternatively, the gamma parameters used for the gamma correction may be switched according to fluctuations in the frequency of the spread spectrum clock signal SS-CK that is generated by the control unit 16. The gamma parameters are data representing the relationship between the gradation and the brightness, and include, e.g., the correction values (look-up table) corresponding to the gradation values or the exponent of the exponential function that approximates to a function (gamma curve) representing the relationship between the input gradation signal and the display brightness (i.e., the gamma characteristics).

In this embodiment, e.g., the gradation correction portion 16b changes the gamma parameters to be referred to depending on the fluctuation period of the drive frequency (e.g., the period of the spread spectrum). For example, the gradation correction portion 16b can reduce the gamma value (i.e., the gamma is on the upper side) so that the brightness is higher than usual at the timing when the charge is likely to be insufficient because the drive frequency is higher than the reference frequency. On the contrary, the gradation correction portion 16b increases the gamma value (i.e., the gamma is on the lower side) at the timing when the charging time is likely to be ensured because the drive frequency is lower than the reference frequency. This can reduce non-uniform brightness that may occur every period of the spread spectrum and improve the display quality during high-speed driving. Specific examples will be described later.

(Configuration Example of Control Unit)

FIG. 3 is a functional block diagram showing a configuration example of the control unit. In the example shown in FIG. 3, the control unit 16 includes an image data acquisition portion 41 for acquiring the input video signal, a chrominance demodulator 42, a signal generator 43, the gradation correction portion 16b, a frequency changing portion 48, a timing controller 51, and a voltage drive circuit 52. The chrominance demodulator 42 and the signal generator 43 use the video signal Data acquired by the image data acquisition portion 41 to generate data signals RGB (which may also be referred to as RGB signals) containing information about the gradation of each pixel, a horizontal synchronizing signal Hsync, and a vertical synchronizing signal Vsync. The gradation correction portion 16b corrects the generated data signals RGB and outputs them to the timing controller 51. The gradation correction portion 16b includes an upper drive voltage value determination circuit 44u and a lower drive voltage value determination circuit 44s. The gradation correction portion 16b can access a memory 50. The upper drive voltage value determination circuit 44u refers to an LUT (look-up table) 47u for reference to upper gamma parameters previously stored in the memory 50, and determines the correction values for the gradation values of the pixels in the upper portion of the display screen. Similarly, the lower drive voltage value determination circuit 44s refers to an LUT (look-up table) 47s for reference to lower gamma parameters previously stored in the memory 50, and determines the correction values for the gradation values of the pixels in the lower portion of the display screen. The upper drive voltage value determination circuit 44u and the lower drive voltage value determination circuit 44s output the gamma-corrected data signals RGB to the timing controller 51.

The frequency changing portion 48 may be formed by a spread spectrum circuit that changes the input reference clock signal CK at a predetermined period and generates a spread spectrum clock signal SS-CK. The spread spectrum clock signal SS-CK is output to the timing controller 51.

In this embodiment, the timing controller 51 also serves as both a source signal generation portion and a gate signal generation portion. The timing controller 51 receives the horizontal synchronizing signal Hsync, the vertical synchronizing signal Vsync, the data signals RGB corrected by the gradation correction portion 16b, and the spread spectrum clock signal SS-CK. The timing controller 51 outputs the gate signal G-Dr and the source signal S-Dr to the gate driver 18 and the source driver 17, respectively, based on the input spread spectrum clock signal SS-CK, horizontal synchronizing signal Hsync, vertical synchronizing signal Vsync, and data signals RGB. In other words, the timing controller 51 controls the voltage drive circuit 52 to supply drive voltages to the gate driver 18 and the source driver 17.

The gate driver 18 applies the drive voltage output from the voltage drive circuit 52 to the gate lines G of the liquid crystal panel 2 based on a horizontal scanning period TH that is controlled by the timing controller 51, and turns on the switching elements 19 of the pixels P connected to those gate lines G.

The source driver 17 applies the drive voltage output from the voltage drive circuit 52 to the source lines S as a source voltage Vs corresponding to the gradation values of the pixels in synchronization with the scanning of the gate lines G performed by the gate driver 18. Similarly to the gate driver 18, the timing controller 51 can also control the timing of the application of the source voltage Vs to the source lines S by the source driver 17.

In the above configuration, the frequency changing portion 48 can change the frequency of the reference clock signal CK so that the upper portion and the lower portion of the display screen differ in the drive frequency. For example, when the relationship TH1>TH2>TH3 is established, the frequency of the reference clock signal CK can be changed so that the horizontal scanning period TH in the upper portion of the display screen is changed in the range of TH1≧TH≧TH2, and the horizontal scanning period TH in the lower portion of the display screen is changed in the range of TH2>TH≧TH3. Thus, the drive frequency in the upper portion can differ from that in the lower portion of the display screen.

The gradation correction portion 16b performs the gamma correction using different gamma parameters with respect to the upper portion and the lower portion of the display screen, and therefore can correct the gradation suitably for the drive frequency in each of the upper portion and the lower portion. Thus, it is possible to suppress non-uniform brightness due to fluctuations in the drive frequency. Moreover, since the liquid crystal display device 1 is controlled based on the spread spectrum clock signal SS-CK, the spectrum of the radiated electromagnetic waves from the liquid crystal display device 1 can be spread so as to reduce the peak of the spectrum, and the EMI reduction can be achieved. In this embodiment, the upper portion and the lower portion of the display screen are examples of a first region and a second region of the display region that differ in the drive frequency.

(Specific Example of Gradation Correction)

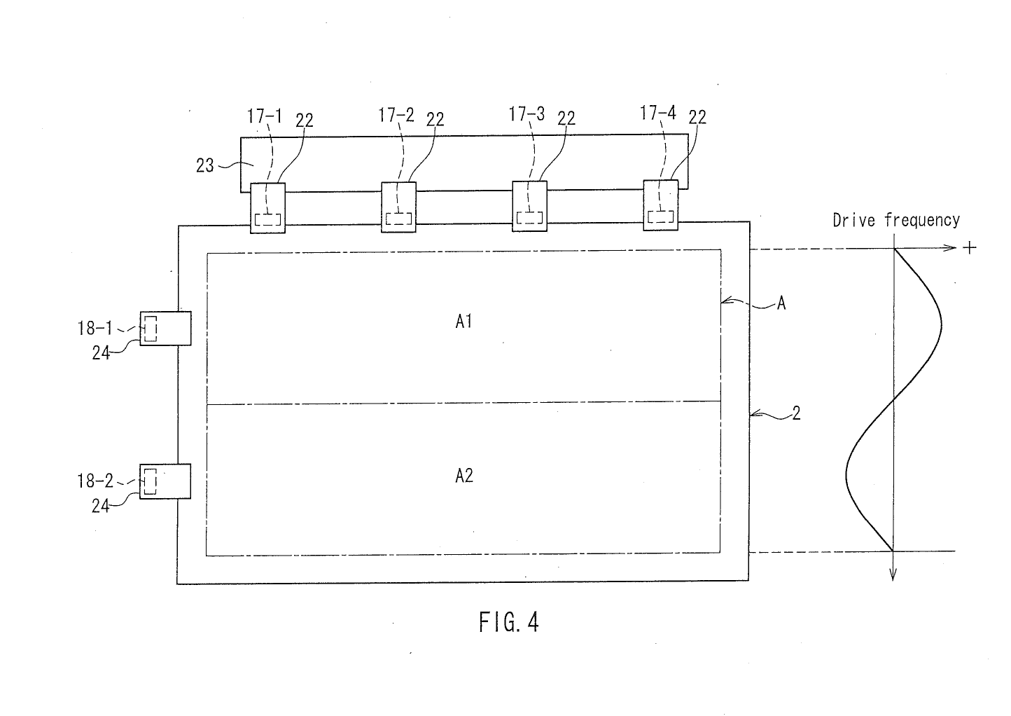

Hereinafter, the source driver 17, the gate driver 18, and a plurality of display areas in the liquid crystal panel 2 of this embodiment will be described in detail with reference to FIG. 4.

FIG. 4 is a diagram for explaining the source driver 17, the gate driver 18, and the display areas provided in the liquid crystal panel 2.

In the example shown in FIG. 4, the liquid crystal panel 2 includes a plurality of e.g., four source drivers 17-1 to 17-4 (which are generically called “17” in the following) mounted on four flexible printed circuit boards (SOF (system on film)) 22, respectively. One end portion of each of the flexible printed circuit boards 22 is connected to the source lines S on the active matrix substrate outside an effective display region A. The same number of source lines S, i.e., (M/4) source lines S are connected to each of the source drivers 17-1 to 17-4.

The other end portion of each of the flexible printed circuit boards 22 is connected to a printed circuit board 23. In the liquid crystal panel 2, the source signal S-Dr corresponding to the information to be displayed on the display portion of the liquid crystal panel 2 is input from the control unit 16 to the source drivers 17-1 to 17-4. Then, each of the source drivers 17-1 to 17-4 applies the source voltage (i.e., inputs the gradation signal) to the corresponding source lines S to control the gradation of each pixel.

Moreover, the liquid crystal panel 2 includes a plurality of e.g., two gate drivers 18-1 to 18-2 (which are generically called “18” in the following) mounted on two flexible printed circuit boards (SOF) 24, respectively. One end portion of each of the flexible printed circuit boards 24 is connected to the gate lines G on the active matrix substrate outside the effective display region A. The same number of gate lines G, i.e., (N/2) gate lines G are connected to each of the gate drivers 18-1, 18-2. The gate drivers 18-1, 18-2 are connected to the control unit 16 via the corresponding flexible printed circuit boards 24 and lines (not shown) provided on the active matrix substrate. Each of the gate drivers 18-1, 18-2 receives the instruction signal from the control unit 16 and applies the gate voltage (i.e., outputs the gate signal) to the corresponding gate lines G.

In the liquid crystal panel 2, as shown in FIG. 4, a plurality of e.g., two display areas A1, A2 are provided in the effective display region A. The display areas A1, A2 include a plurality of pixels P provided at the intersections of the source lines S and the gate lines G that are arranged in a matrix. For example, the display area A1 includes the pixels P provided at the intersections of the source lines S connected to the source drivers 17-1 to 17-4 and the gate lines G connected to the gate driver 18-1.

In other words, four source drivers 17 and one gate driver 18 are allocated to each of the display areas A1, A2. Accordingly, the source drivers 17-1 to 17-4 and the gate driver 18-1 are allocated to the display area A1, and the source drivers 17-1 to 17-4 and the gate driver 18-2 are allocated to the display area A2.

In the liquid crystal panel 2, as shown in FIG. 4, the source drivers 17-1 to 17-4 are located at different distances from the gate driver 18. In this case, e.g., the gradation correction portion 16b may perform the gamma correction so that the gradation voltage that has been corrected using different gamma parameters according to the distance from the gate driver 18 is input from the control unit 16 to the source drivers 17-1 to 17-4.

The gradation correction portion 16b determines the correction values for the gradation values contained in the external video signal, i.e., the corrected gradation values for each of the pixels P with respect to the display areas A1, A2. The timing controller 51 controls the voltage drive circuit 52 to apply the gradation voltage to the liquid crystal panel 2 in accordance with the correction values determined by the gradation correction portion 16b.

The frequency changing portion 48 can change the frequency of the reference clock signal CK at a predetermined fluctuation period so that the display area A1 and the display area A2 differ in the drive frequency. Thus, the fluctuation range of the drive frequency in the display area A1 can differ from that of the drive frequency in the display area A2.

For example, the frequency changing portion 48 can set the period of the spread spectrum SS (i.e., the fluctuation period of drive frequency) to 1 V (=frame). The graph on the right of FIG. 4 shows an example of fluctuations in the drive frequency in the longitudinal direction (vertical direction) of the display screen. In this case, the drive frequency is a reference value at the upper end of the display region A of the liquid crystal panel 2. The drive frequency is gradually increased from the upper end down to the lower side of the panel, and reaches a maximum value at the ¼ position from the upper end. Subsequently, the drive frequency is reduced and returns to the reference value at the ½ position from the upper end. Thereafter, the drive frequency is minimized at the ¾ position from the upper end, and again returns to the reference value at the lower end of the panel. In the example shown in FIG. 4, the initial phase of the drive frequency is 0 (i.e., the amount of fluctuation at the start (time=0) of 1 frame is 0). Then, the drive frequency fluctuates over time, and the amount of fluctuation becomes 0 again at ½ of the fluctuation period Ts. In such a case, the drive frequency fluctuates between the reference value (i.e., the median in this example) and the maximum value in the upper display area A1 of the display region A, and the drive frequency fluctuates between the reference value and the minimum value in the lower display area A2 of the display region A. As described above, since the frame of the panel coincides with the fluctuation period of the drive frequency, the gamma parameters to be referred to for each horizontal line can be made constant. In this embodiment, two different types of gamma parameters are referred to for the upper half and the lower half of the panel, respectively. Thus, the drive control can be performed relatively easily.

The fluctuation period of the drive frequency will be described in the following. It is preferable that the value obtained by multiplying one-half the fluctuation period Ts of the drive frequency by N (N is a natural number) is a scanning period Tv (N·Ts/2=Tv) of all the scanning lines. In this case, the distribution of the drive frequency in the display region is fixed or changed regularly. Therefore, the gamma correction can be performed by dividing the display region into a plurality of areas (e.g., A1 and A2 shown in FIG. 4) according to the distribution of the drive frequency, and using different gamma parameters for each of the areas.

It is more preferable that the scanning period Tv of all the scanning lines is M times the fluctuation period Ts (M is a natural number; Tv=MTs). In this case, the distribution of the drive frequency is fixed, and the gamma parameters used for each of the divided areas can be made constant. Thus, the division of the display region into a plurality of areas can be uniform.

For example, in the example shown in FIG. 4, the scanning period Tv of all the scanning lines is equal to the fluctuation period Ts (M=1, Tv=Ts). In this case, the drive frequency always fluctuates in a high band (between the reference value and the maximum value) in the upper half area A1 of the display region, and the drive frequency fluctuates in a low band (between the reference value and the minimum value) in the lower half area A2 of the display region. Therefore, as shown in FIG. 3, the gradation correction portion 16b can use the upper gamma parameters to gamma-correct the gradation values of the pixels in the upper area A1 and the lower gamma parameters to gamma-correct the gradation values of the pixels in the lower area A2. In the example shown in FIG. 4, the scanning period Tv of all the scanning lines corresponds to a period (vertical scanning time or vertical scanning period) from the time at which a row in the display screen is selected to the time at which the same row is selected next.

(Example of Gamma Correction)

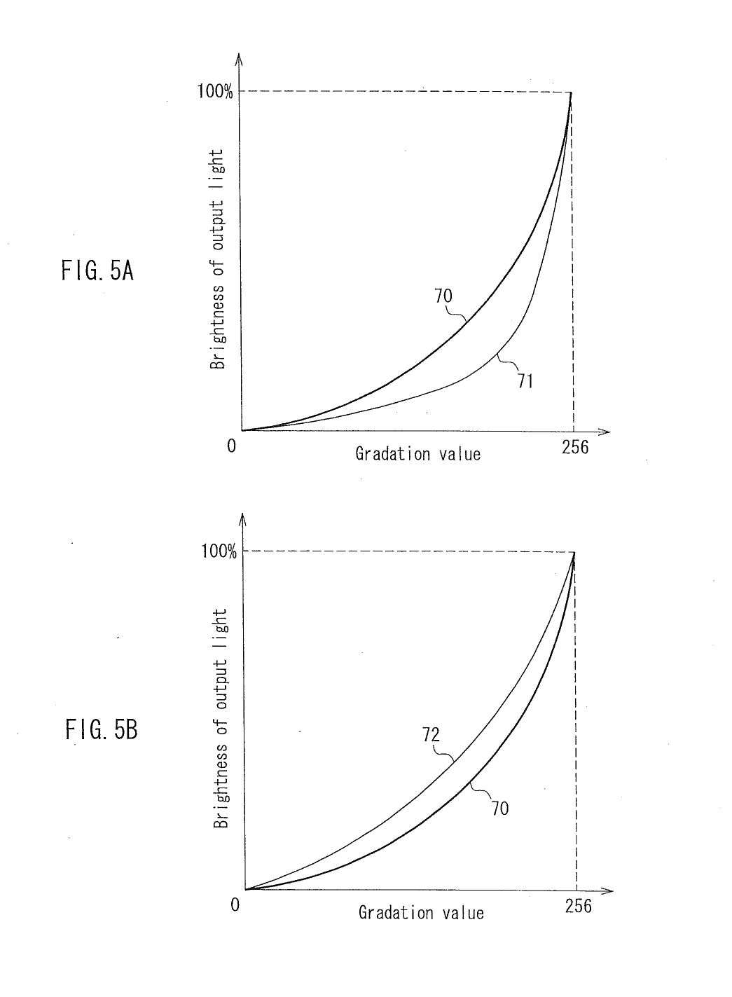

FIGS. 5A and 5B are graphs for explaining specific examples of the correction values that are determined by the gradation correction portion shown in FIG. 2 with respect to different display areas, respectively. In FIGS. 5A and 5B, when the lateral axis is the x axis and the longitudinal axis is the y axis, all curves 70, 71, and 72 are expressed by the formula y=x^{γ}(y=x̂γ). The values of the gamma curves (i.e., the gamma values in this example) are “2.2”, “2.3”, and “2.1” for the curves 70, 71, and 72, respectively. In this case, e.g., the gamma curve represented by the curve 70 is set as desired gamma characteristics of the liquid crystal panel 2.

The gradation correction portion 16b of this embodiment determines the corrected gradation values using the predetermined different gamma curves with respect to the display areas of the display region that differ in the drive frequency. Specifically, the display screen A is divided into the upper half display area A1 and the lower half display area A2. The gradation correction portion 16b is configured to use the gamma curves with different values for each of the display areas A1, A2. That is, one of the gamma curves is used to correct the gradation values that are to be indicated by the source signals of the source drivers 17-1 to 17-4 when any of the gate signals of the gate driver 18-1 (allocated to the display area A1) is ON. The other of the gamma curves is used to correct the gradation values that are to be indicated by the source signals of the source drivers 17-1 to 17-4 when any of the gate signals of the gate driver 18-2 is ON.

For example, the gradation correction portion 16b can reduce the gamma value (i.e., the gamma is on the upper side) so that the brightness is higher than usual at the timing when the charge is likely to be insufficient because the frequency is higher than the reference frequency (i.e., the timing when the brightness of the pixels in the display area A1 is controlled). In other words, the gradation correction portion 16b corrects the gradation values using the gamma curve represented by the curve 72 in FIG. 5B. For example, when the gradation values are expressed by 8 bits (=256 levels of gray), the y values on the curve 72 corresponding to the 256 gradation values on the x axis are stored in a table as correction values, and this table can be identified as the LUT 47u for reference to upper gamma parameters. Thus, the gamma characteristics can be closer to the desired gamma curve (curve 70).

On the contrary, the gradation correction portion 16b increases the gamma value (i.e., the gamma is on the lower side) at the timing when the charging time is likely to be ensured because the frequency is lower than the reference frequency (i.e., the timing when the brightness of the pixels in the display area A2 is controlled). In other words, the gradation correction portion 16b corrects the gradation values using the gamma curve represented by the curve 71 in FIG. 5A. For example, when the gradation values are expressed by 8 bits (=256 levels of gray), the y values on the curve 71 corresponding to the 256 gradation values on the x axis are stored in a table as correction values, and this table can be identified as the LUT 47s for reference to lower gamma parameters. Thus, the gamma characteristics can be closer to the desired gamma curve (curve 70).

As described above, the gradation correction portion 16b can make the value of the gamma curve used for the source signal when any of the gate lines is selected by the gate driver 18-2 in the lower display area A2 smaller than that of the gamma curve used for the source signal when any of the gate lines is selected by the gate driver 18-1 in the upper display area A1.

In other words, the gradation correction portion 16b determines the correction values for the gradation values using the gamma curve with a larger value for the source signal of the pixels in the display area A1, where the charge of the gradation voltage is likely to be insufficient due to a high drive frequency, and thus the charging rate of the liquid crystal layer for each pixel is likely to be low, than for the source signal of the pixels in the display area, where the drive frequency is low. This can reduce non-uniform brightness that may occur every period of the spread spectrum and improve the display quality during high-speed driving.

The correction data that indicates the amount of correction for the gradation values in accordance with the drive frequency can be previously determined by performing verification tests or simulations using actual products. For example, when the verification tests or simulations using actual products are performed at various drive frequencies, the corrected gradation values (output gradation data) can be previously determined with respect to the gradation values (input gradation data), which have been contained in the external video signal, for each of the pixels P so that the brightness of the output light that is emitted from these pixels P to the outside has a desired value. Moreover, based on the relationship between the input gradation data and the output gradation data thus obtained, any formulas or data such as parameters required for the operation to calculate the output gradation data from the input gradation data can be determined and stored in the memory 50 in advance. The gradation correction portion 16b uses the gradation values contained in the external video signal and the data stored in the memory 50 to generate the source signal S-Dr indicating the predetermined gradation values. Thus, in this embodiment, as described above, the corrected gradation values can be determined by using the predetermined different gamma curves with respect to the display areas A1, A2.

Other than the above description, e.g., the gradation correction portion 16b may appropriately calculate the correction data stored in the memory 50 while performing the operation or may dynamically receive the correction data from the outside. With this configuration, the placement of the memory 50 can be eliminated.

In the control unit (control system) 16 of this embodiment having the above configuration, the gradation correction portion 16b determines the correction values for the gradation values, which have been contained in the external video signal, for each of the pixels P with respect to the display areas A1, A2. Then, the source signal S-Dr containing the corrected gradation values is output to the source driver 17. Thus, unlike the conventional examples, this embodiment can suppress the degradation of the display quality even if the drive frequency of the liquid crystal panel 2 is changed.

In this embodiment, the gradation correction portion 16b corrects the corresponding gradation values, which have been contained in the external video signal, to the predetermined gradation values so that the brightness of the output light that is emitted from the pixels P to the outside has a desired value. Thus, this embodiment can improve the characteristics of the brightness of the output light and the gradation values, and can reliably improve the display quality even if the drive frequency of the liquid crystal panel 2 is changed.

In this embodiment, the gradation correction portion 16b determines the correction values for the gradation values, which have been contained in the external video signal, for each of the pixels P by referring to the correction data that has been previously stored and indicates the correction values for the gradation values. Therefore, the gradation values can be appropriately determined.

In this embodiment, the correction portion 16b determines the corrected gradation values using the predetermined different gamma curves with respect to the display areas A1, A2 that differ in the drive frequency. Thus, in this embodiment, even if the drive frequency of the liquid crystal panel 2 is changed, the corrected gradation values can be appropriately determined in accordance with the drive frequency in each of the display areas A1, A2, so that the display quality can be improved.

This embodiment uses the gradation correction portion (gradation correction system) 16b that can improve the display quality even if the drive frequency of the liquid crystal panel (display panel) 2 is changed, and thus can easily provide the liquid crystal display device 1 with excellent display quality.

In this embodiment, the liquid crystal panel 2 is used as a display panel, and the liquid crystal panel 2 includes a plurality of gates drivers 18-1, 18-2 and a plurality of source drives 17-1 to 17-4. Moreover, the gradation voltage, which is determined by using different gamma curves for each of the timing when the gate signal is turned on by the first gate drive 18-1 and the timing when the gate signal is turned on by the second gate driver 18-2, is applied to the source lines. Thus, this embodiment can easily provide the liquid crystal display device 1 with excellent display quality.

### Second Embodiment

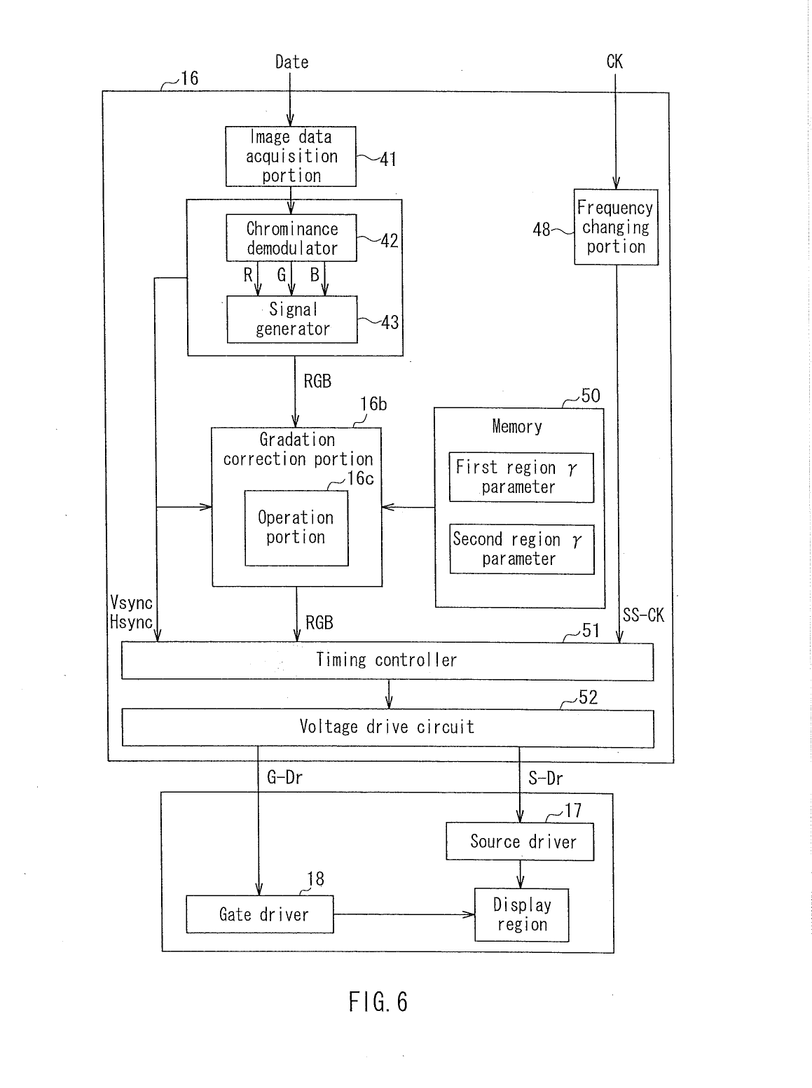

FIG. 6 is a functional block diagram showing a configuration example of a control unit of Embodiment 2. In this embodiment, the gradation correction portion 16b of the control unit 16 includes an operation portion 16c. The operation portion 16c receives the signals RGB that are generated by the chrominance demodulator 42 and the signal generator 43 and indicate the gradation of each pixel, and performs an operation to determine the correction values for the gradation values indicated by the signals RGB. In this embodiment, the display region of the liquid crystal panel 2 is divided into a plurality of regions (first display region and second display region) that differ in the drive frequency. The operation portion 16c performs a first operation to determine the correction values for the gradation values of the pixels in the first display region, and a second operation to determine the correction values for the gradation values of the pixels in the second display region. The first display region and the second display region may be set, e.g., as the display area A1 and the display area A2 (see FIG. 4) of Embodiment 1, but are not limited thereto.

In the example shown in FIG. 6, the operation portion 16c performs an operation to determine the correction values for the gradation values with respect to a plurality of regions that differ in the drive frequency. Therefore, the gamma parameters used for the operation are stored for each of the regions in the memory 50. For example, the memory 50 stores the gamma parameters for the first region and the gamma parameters for the second region. The operation portion 16c switches the gamma parameters used for the operation between the regions, so that the operation method of the correction values for the gradation values can differ from one region to another.

The operation portion 16c can receive the horizontal synchronizing signal Hsync and the vertical synchronizing signal Vsync as well as the signals indicating the gradation values. In this case, e.g., at least one of the input horizontal synchronizing signal Hsync and vertical synchronizing signal Vsync may be used to decide which display region the pixels having the gradation values indicated by the signals RGB belong to. Thus, the operation method can be switched according to the display region to which the pixels belong. For example, as shown in FIG. 4, when the display screen A is divided into the upper display area A1 where the drive frequency is high and the lower display area A2 where the drive frequency is low, the gradation correction portion 16b can decide from the vertical synchronizing signal Vsync whether the received signals RGB indicate the gradation of the pixels in the upper display area A1 or indicate the gradation of the pixels in the lower display area A2.

For example, the operation portion 16c can reduce the gamma value (i.e., the gamma is on the upper side) in the operation of the gamma correction so that the brightness is higher than usual at the timing when the charge is likely to be insufficient because the drive frequency is higher than the reference frequency (i.e., the timing when the brightness of the pixels in the display area A1 is controlled). In other words, the operation portion 16c can correct the gradation values using the gamma curve represented by the curve 72 in FIG. 5B. For example, the gamma value “2.1” of the curve 72 can be previously stored in the memory 50 as a gamma parameter for the first region. When the gradation values of the pixels in the display area A1 are corrected, the operation portion 16c can use the gamma value “2.1” to calculate the correction value y=x̂γ for the gradation value x. Thus, the gamma characteristics can be closer to the desired gamma curve (curve 70).

On the contrary, the operation portion 16c increases the gamma value (i.e., the gamma is on the lower side) at the timing when the charging time is likely to be ensured because the frequency is lower than the reference frequency (i.e., the timing when the brightness of the pixels in the display area A2 is controlled). In other words, the operation portion 16c corrects the gradation values using the gamma curve represented by the curve 71 in FIG. 5A. For example, the gamma value “2.3” of the curve 71 can be previously stored in the memory 50 as a gamma parameter for the second region. When the gradation values of the pixels in the display area A2 are corrected, the operation portion 16c can use the gamma value “2.3” to calculate the correction value y=x̂γ for the gradation value x. Thus, the gamma characteristics can be closer to the desired gamma curve (curve 70).

In this embodiment, the operation can be switched in accordance with the drive frequency, and thus appropriate correction values can be calculated. This can reduce non-uniform brightness that may occur due to fluctuations in the frequency and improve the display quality during high-speed driving. This embodiment is a modified example of Embodiment 1, and the configuration and function (e.g., the frequency changing portion or the like) other than the operation portion 16c may be the same as those of Embodiment 1.

### MODIFIED EXAMPLES

Next, modified examples that can be applied to both Embodiments 1 and 2 will be described.

### Modified Example 1

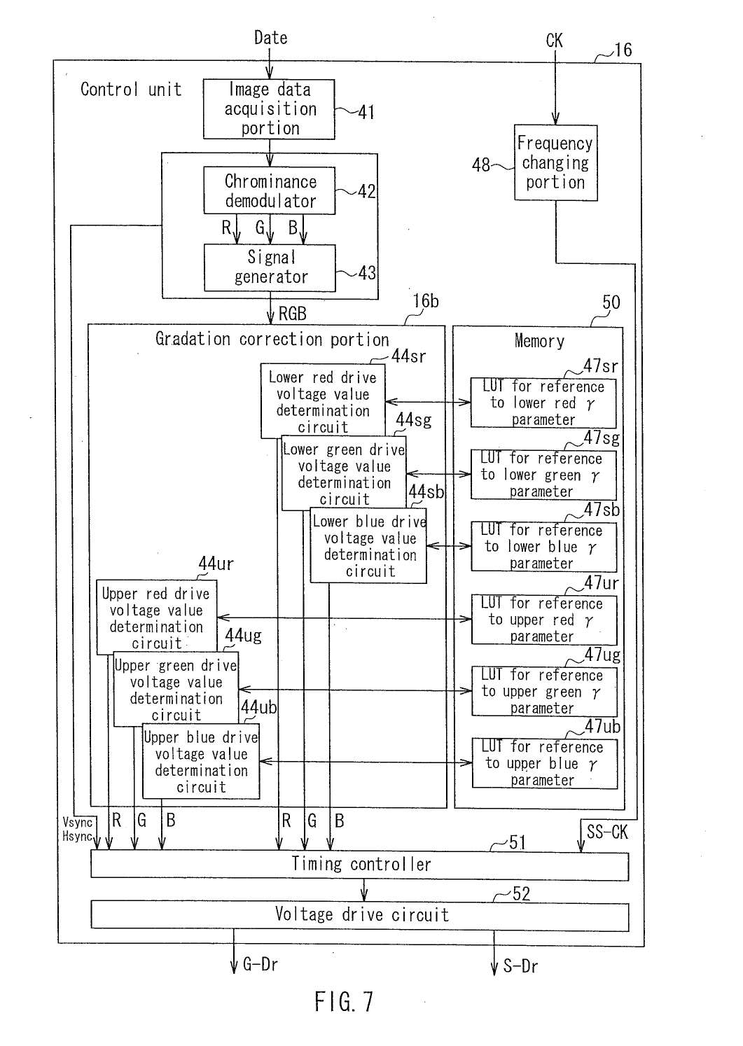

FIG. 7 is a functional block diagram showing the configuration of a control unit of a first modified example. In the modified example shown in FIG. 7, the gradation correction portion determines the correction values for the gradation values of the pixels for each color of red, green, and blue provided in the liquid crystal panel with respect to a plurality of display areas that differ in the drive frequency. In the modified example shown in FIG. 7, the same components as those of Embodiment 2 are denoted by the same reference numerals, and the explanation will not be repeated.

In the example shown in FIG. 7, the gradation correction portion 16b includes drive voltage value determination portions that determine the correction values for the corresponding gradation values, which have been contained in the external video signal, for each color of the red, green, and blue pixels P with respect to the display areas A1, A2. Specifically, the gradation correction portion 16b includes lower red, green, and blue drive voltage value determination portions 44sr, 44sg, and 44sb and upper red, green, and blue drive voltage value determination portions 44ur, 44ug, and 44ub. Similarly to Embodiments 1 and 2, the memory 50 includes LUs 47sr, 47sg, 47sb and LUTs 47ur, 47ug, 47ub, each of which holds the gradation values before and after the correction in relation to each other. These LUTs 47 are separated into two groups for the display areas A1, A2, and each group includes three tables showing the red, green, and blue gradation correction values, respectively. The drive voltage value determination portions 44 refer to the respective LUTs 47 stored in the memory 50, correct the input gradation values, and determine a drive voltage value (source signal S-Dr) to be applied to the source lines.

Specifically, in the LUT 47sr, the gradation values (input gradation data), which have been contained in the external video signal, for each of the red pixels Pr in the lower display area A2 are related to the corrected gradation values (output gradation data) so that the brightness of the output light that is emitted from these pixels Pr to the outside has a desired value. The LUT 47ur relates the input gradation values for each of the red pixels Pr in the upper display area A1 to the corrected gradation values.

Similarly, in the LUT 47sg, the gradation values (input gradation data), which have been contained in the external video signal, for each of the green pixels Pg in the lower display area A2 are related to the corrected gradation values (output gradation data) so that the brightness of the output light that is emitted from these pixels Pg to the outside has a desired value. The LUT 47ug relates the input gradation values for each of the green pixels Pg in the upper display area A1 to the corrected gradation values.

Similarly, in the LUT 47sb, the gradation values (input gradation data), which have been contained in the external video signal, for each of the blue pixels Pb in the lower display area A2 are related to the corrected gradation values (output gradation data) so that the brightness of the output light that is emitted from these pixels Pb to the outside has a desired value. The LUT 47ub relates the input gradation values for each of the blue pixels Pb in the upper display area A1 to the corrected gradation values.

Upon receiving the input gradation data, which has been contained in the external video signal, for each of the red pixels Pr in the upper display area A1, the upper red drive voltage value determination circuit 44ur retrieves the corresponding output gradation data from the LUT 47ur. The retrieved data is output to the source driver 17 via the timing controller as the corrected gradation values. Upon receiving the input gradation data, which has been contained in the external video signal, for each of the red pixels Pr in the lower display area A2, the lower red drive voltage value determination circuit 44sr retrieves the corresponding output gradation data from the LUT 47sr and outputs the retrieved data as the corrected gradation values.

Similarly, upon receiving the input gradation data, which has been contained in the external video signal, for each of the green pixels Pg in the upper display area A1, the upper green drive voltage value determination circuit 44ug retrieves the corresponding output gradation data from the LUT 47ug. The retrieved data is output to the source driver 17 via the timing controller as the corrected gradation values. Upon receiving the input gradation data, which has been contained in the external video signal, for each of the green pixels Pg in the lower display area A2, the lower green drive voltage value determination circuit 44sg retrieves the corresponding output gradation data from the LUT 47sg and outputs the retrieved data as the corrected gradation values.

Similarly, upon receiving the input gradation data, which has been contained in the external video signal, for each of the blue pixels Pb in the upper display area A1, the upper blue drive voltage value determination circuit 44ub retrieves the corresponding output gradation data from the LUT 47ub. The retrieved data is output to the source driver 17 via the timing controller as the corrected gradation values. Upon receiving the input gradation data, which has been contained in the external video signal, for each of the blue pixels Pb in the lower display area A2, the lower blue drive voltage value determination circuit 44sb retrieves the corresponding output gradation data from the LUT 47sb and outputs the retrieved data as the corrected gradation values.

As described above, in this modified example, the gradation correction portion 16b determines the correction values for the corresponding gradation values, which have been contained in the external video signal, for each color of the red, green, and blue pixels Pr, Pg, and Pb provided in the liquid crystal panel 2 with respect to the display areas A1, A2. Thus, this embodiment can easily adjust the gradation of each color and the white balance (color temperature), and also can easily improve the display quality. Moreover, this embodiment can have the same effects as those in Embodiments 1 and 2. The gradation correction portion 16b corrects the gradations of red, green, and blue independently for each of the display regions that differ in the drive frequency. Thus, the gradation correction suitable for each of the red, green, and blue pixels can be performed in accordance with the drive frequency. Therefore, this embodiment is more effective in reducing non-uniform brightness that may occur due to fluctuations in the frequency and improving the display quality during high-speed driving.

For example, the gamma correction can be performed by using different gamma parameters for each of the red, green, and blue pixels with respect to the display regions that differ in the drive frequency. In this case, e.g., the gamma parameters suitable for red, green, and blue can be used.

### Modified Example 2

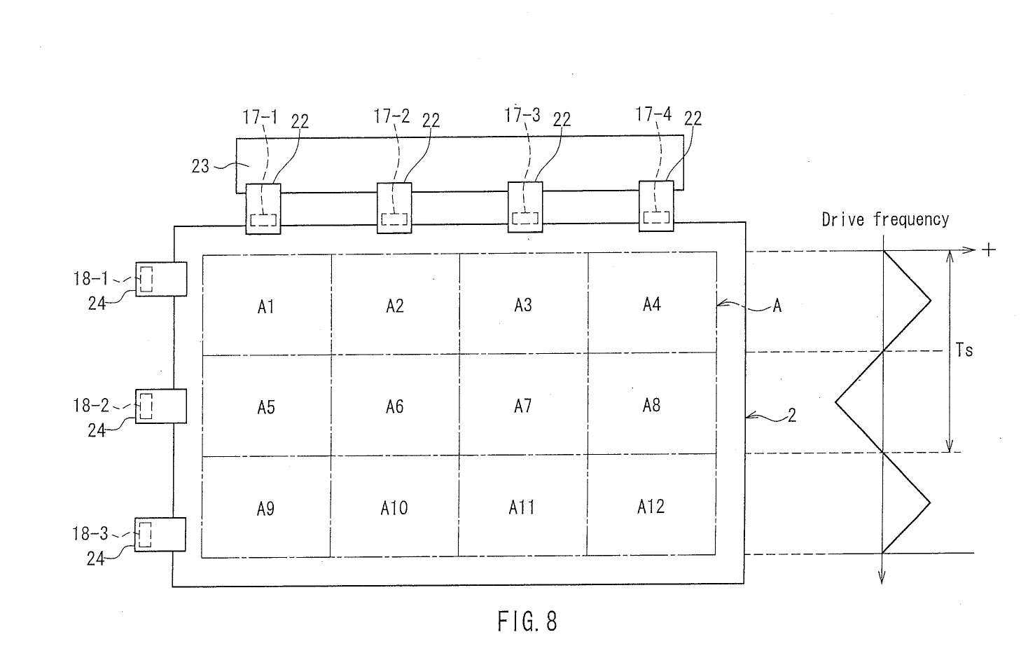

FIG. 8 is a diagram showing an example in which the setting of display areas in a display screen and the way that the frequency fluctuates are altered. As shown in FIG. 8, the value obtained by multiplying one-half the fluctuation period Ts by 3 can be set to a scanning period Tv of all the scanning lines. In this case, when scanning is performed for one frame, the drive frequency can fluctuate between a reference value and a maximum value in both a region extending to ⅓ of the way down from the upper end of the display screen and a region extending to ⅓ of the way up from the lower end of the display screen, and the drive frequency can fluctuate between the reference value and a minimum value in the remaining region of ⅓, i.e., the middle portion of the display screen. During scanning for the next one frame, the fluctuation range of the drive frequency is reversed in the above three regions. Accordingly, the drive frequency fluctuates between the reference value and the minimum value in both the region extending to ⅓ of the way down from the upper end of the display screen and the region extending to ⅓ of the way up from the lower end of the display screen, and the drive frequency fluctuates between the reference value and the maximum value in the remaining region of ⅓, i.e., the middle portion of the display screen.

In the example shown in FIG. 8, the display region is also divided into four columns in the horizontal direction. Thus, the gradation can be corrected according to the distance from the gate diver 18, so that the display quality can be improved further.

### Modified Example 3

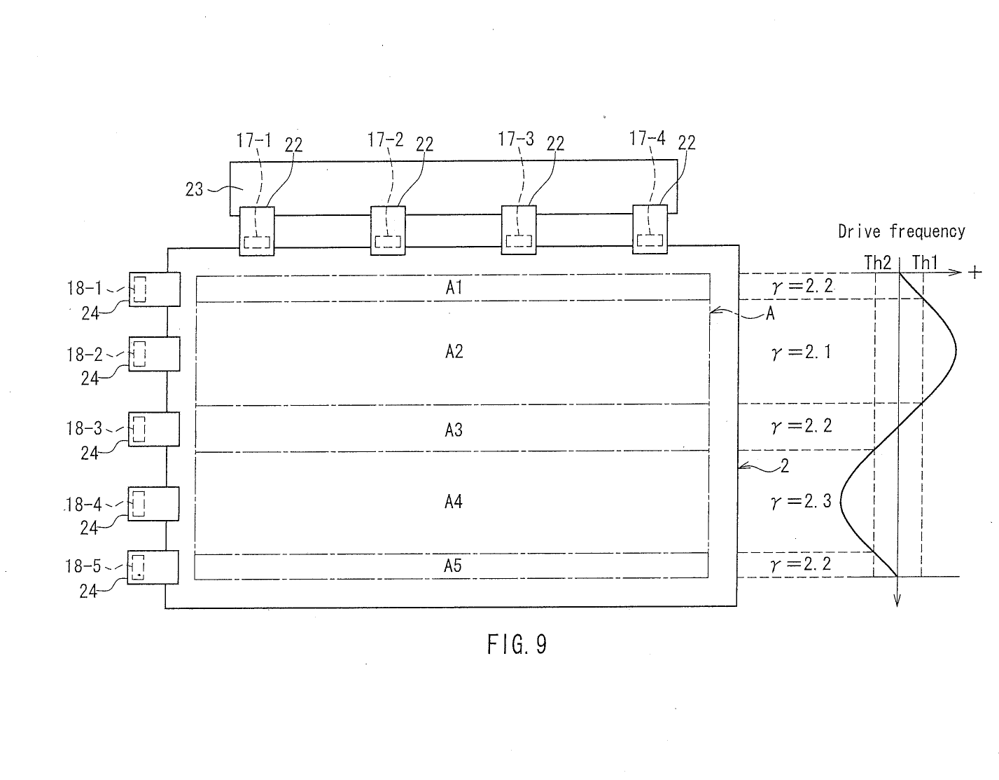

In the example shown in FIG. 4, the gradation correction portion 16b uses the gamma curves with different values separately for the upper display area A1 and the lower display area A2 of the display region. However, the present invention is not limited thereto. For example, as shown in FIG. 9, the display region may be divided into five display areas including an upper portion (e.g., a region A2 where the drive frequency is higher than a threshold value Th1), a middle portion (e.g., regions A1, A3, and A5 where the drive frequency is between the threshold value Th1 and a threshold value Th2), and a lower portion (e.g., a region A4 where the drive frequency is lower than the threshold value Th2), and the gamma curves with different gamma values may be used for each of the display areas. In the example shown in FIG. 9, the gamma curve with a relatively small gamma value (e.g., γ=2.1) is used in the region A2 where the drive frequency is high, the gamma curve with a relatively large gamma value (e.g., γ=2.3) is used in the region A4 where the drive frequency is low, and the gamma curve with an intermediate gamma value (e.g., γ=2.2) is used in the other regions.

### Modified Example 4

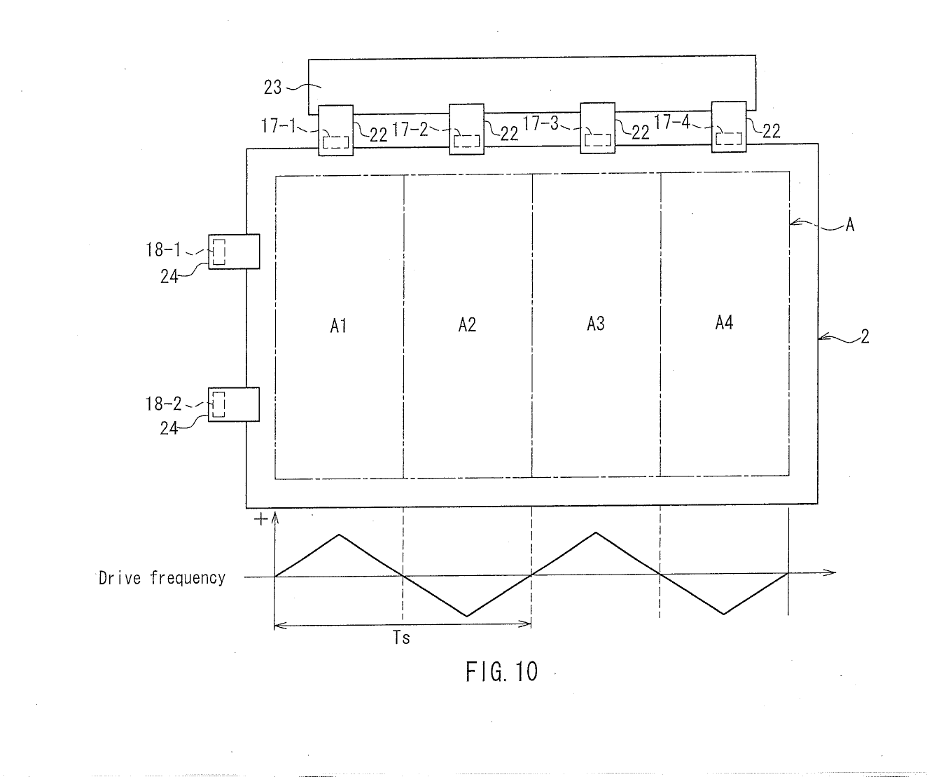

In Embodiments 1 and 2, the display region is divided longitudinally (i.e., in the vertical direction), and the gamma curves with different values are used for each of the divided regions. However, the present invention is not limited thereto. For example, as shown in FIG. 10, the display region may be divided laterally (i.e., in the horizontal direction). In this case, it is preferable that the value obtained by multiplying one-half the fluctuation period Ts of the drive frequency by L (L is a natural number) is a scanning time TH of one scanning line (gate line) (TH=½·L·Ts). It is more preferable that the scanning time TH of one scanning line (gate line) is K times (K is a natural number) the fluctuation period Ts of the drive frequency (TH=K·Ts). In this example, the scanning time TH of one scanning line corresponds to a period (horizontal scanning time or horizontal scanning period) from the time at which a row (gate line) in the display screen is selected to the time at which the next row (gate line) is selected.

In the example shown in FIG. 10, the display screen A is divided into a region (display areas A1, A3) where the drive frequency is higher than a reference value and a region (display areas A2, A4) where the drive frequency is lower than the reference value. In the display areas A1, A3 and the display areas A2, A4, the gradation values can be corrected by using the gamma curves with different gamma values, respectively. For example, the gamma curve with a relatively small gamma value can be used in the regions A1, A3 where the drive frequency is high, and the gamma curve with a relatively large gamma value can be used in the region A2, A4 where the drive frequency is low.

There is no particular limitation to the waveform showing fluctuations in the drive frequency. For example, the fluctuations can follow a sine curve, as shown in FIGS. 4 and 9, or a line with a slope, as shown in FIGS. 8 and 10.

### Embodiment 3

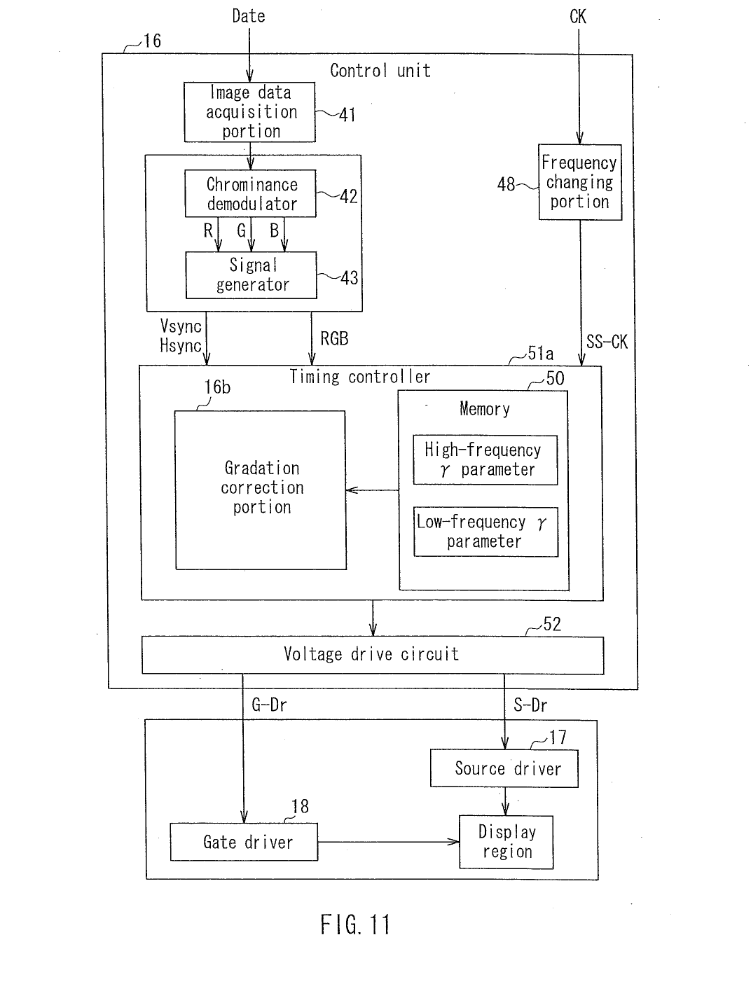

FIG. 11 is a functional block diagram showing a configuration example of a control unit of Embodiment 3. In the example shown in FIG. 11, a timing controller 51a includes the gradation correction portion 16b. The timing controller 51a receives the horizontal synchronizing signal Hsync, the vertical synchronizing signal Vsync, the data signals RGB, and the clock signal whose frequency fluctuates at a predetermined fluctuation period (e.g., the spread spectrum clock signal SS-CK that is changed by the spread spectrum (SS)), and outputs the source signal S-Dr and the gate signal G-Dr. The gradation correction portion 16b of this embodiment determines the correction values for the gradation values of the pixels using the signal for controlling the drive frequency (in this case, e.g., the spread spectrum clock signal SS-CK). In other words, the gradation correction portion 16b determines both the correction values for the gradation values of the pixels that are driven in a time period during which the drive frequency is high and the correction values for the gradation values of the pixels that are driven in a time period during which the drive frequency is low by referring to different correction data or performing different operations.

For example, the gradation correction portion 16b monitors the spread spectrum clock signal SS-CK having a clock frequency that fluctuates at a predetermined fluctuation period Ts, and decides a time period during which the clock frequency is high and a time period during which the clock frequency is low in the fluctuation period T′. For example, let us assume that the clock frequency fluctuates in the fluctuation period Ts as follows: the clock frequency is increased from a reference value to a maximum value in a first time period of ¼Ts; the clock frequency is reduced in a second time period of ¼Ts; the clock frequency returns to the reference value at a time of ½Ts; the clock frequency is further reduced to a minimum value at a time ¾Ts; and then the clock frequency is increased and returns to the reference value at Ts. In this case, the gradation correction portion 16b can decide that a time period of ½Ts in the first half of the fluctuation period Ts is a time period during which the clock frequency is high, and a time period of ½Ts in the second half of the fluctuation period Ts is a time period during which the clock frequency is low. The method for deciding a time period during which the periodically fluctuating drive frequency is high or low is not limited to the above.

The gradation correction portion 16b uses high-frequency correction data (e.g., a high-frequency gamma parameter in this embodiment) to correct the gradation values of the pixels to which the source voltage is applied in the time period of the fluctuation period Ts during which the clock frequency is high. Moreover, the gradation correction portion 16b uses low-frequency correction data (e.g., a low-frequency gamma parameter in this embodiment) to correct the gradation values of the pixels to which the source voltage is applied in the time period of the fluctuation period Ts during which the clock frequency is low.

For example, the gradation correction portion 16b can reduce the gamma value used for the gamma correction so that the brightness is higher than usual at the timing when the charge is likely to be insufficient because the drive frequency is higher than the reference frequency. On the contrary, the gradation correction portion 16b can increase the gamma value used for the gamma correction at the timing when the charging time is likely to be ensured because the frequency is lower than the reference frequency. Similarly to Embodiments 1 and 2, the gradation correction portion 16b may correct the gradation either by referring to the LUT or by performing an operation with the use of a function that approximates the gamma curve.

In this embodiment, the signal for controlling the drive frequency can be used to decide timing when the drive frequency is high (i.e., timing when the drive frequency is higher than that before and after the timing or reaches a maximum value) and timing when the drive frequency is low (i.e., timing when the drive frequency is lower than that before and after the timing or reaches a minimum value). Therefore, the correction of the gradation values of the pixels into which the source signal is written in the time period during which the drive frequency of the liquid crystal panel 2 is high can be performed independently of the correction of the gradation values of the pixels into which the source signal is written in the time period during which the drive frequency of the liquid crystal panel 2 is low. Thus, the gradation can be appropriately corrected in accordance with the fluctuating drive frequency. Moreover, even if the region where the drive frequency is high and the region where the drive frequency is low are not uniform in the display screen, the gradation can be corrected according to fluctuations in the drive frequency. Consequently, this embodiment can achieve the effects of reducing non-uniform brightness that may occur due to fluctuations in the frequency and improving the display quality during high-speed driving.

In this embodiment, a time period during which the drive frequency is higher than that before and after the time period, and a time period during which the drive frequency is lower than that before and after the time period are decided, and different gradation corrections are performed on each of the time periods thus decided. However, at least one of the time period during which the drive frequency is high and the time period during which the drive frequency is low may be decided, and a gradation correction may be performed on the at least one of the time periods thus decided. Moreover, the gradation correction in accordance with the drive frequency of this embodiment can also be applied to Embodiment 1 or Embodiment 2.

(Other Configurations)

The present invention is not limited to Embodiments 1 to 3. For example, the gradation correction performed by the gradation correction portion 16b does not necessarily have to be a gamma correction. Any gradation corrections other than the gamma correction may be performed by using data or a function representing the relationship between the gradation values indicated by the input signal and the gradation values (correction values) of the output signal.

Moreover, a change in the drive frequency is not limited to the spread spectrum (SS) in the above embodiments. Any frequency changing techniques other than the SS can also be used.

Although the liquid crystal display device as well as the liquid crystal panel including the control unit is one of the embodiments of the present invention, the display device to which the present invention is applicable is not limited to the liquid crystal panel and the liquid crystal display device. For example, the present invention is applicable to any display panels or display devices such as an organic EL display and a plasma display having a configuration in which pixels are arranged in a matrix, and the brightness of each of the pixels is controlled by scanning lines and data lines that intersect the scanning lines.

### INDUSTRIAL APPLICABILITY

The present invention is useful for a display device that can improve the display quality even if the drive frequency is changed.

### DESCRIPTION OF REFERENCE NUMERALS

Liquid crystal display device
2 Liquid crystal panel (display portion)
3 Backlight device (backlight portion)
4 Light emitting diode (light source)
16 Control unit
16b Gradation correction portion
16c Operation portion
17 Source driver
18 Gate driver
44 Drive voltage value determination circuit
47 LUT
48 Frequency changing portion
50 Memory
51 Timing controller
52 Voltage drive circuit
A1-A12 Display area

1: A control unit that is provided in a display device having a plurality of pixels and controls a display signal indicating gradation of the pixels, comprising:
a gradation correction portion that determines correction values for gradation values of each of the pixels indicated by the display signal in accordance with a drive frequency of the pixels.

2: The control unit according to claim 1, wherein the gradation correction portion determines the correction values for the gradation values of each of the pixels in a first display region of the display device and the correction values for the gradation values of each of the pixels in a second display region of the display device, and
wherein the drive frequency of the pixels in the first display region differs from the drive frequency of the pixels in the second display region.

3: The control unit according to claim 2, wherein the gradation correction portion determines the correction values for the pixels in the first display region by referring to first correction data that has been previously stored and indicates a first amount of correction for the gradation values, and the gradation correction portion determines the correction values for the pixels in the second display region by referring to second correction data that has been previously stored and indicates a second amount of correction for the gradation values.

4: The control unit according to claim 2, wherein the gradation correction portion includes an operation portion that determines the correction values by performing an operation using the gradation values of each of the pixels contained in the display signal, and
wherein the operation portion performs a first operation to determine the correction values for the gradation values of the pixels in the first display region and a second operation to determine the correction values for the gradation values of the pixels in the second display region.

5: The control unit according to claim 1, wherein the display device has scanning lines provided for each line of the pixels that are arranged in a matrix, and the drive frequency of the pixels is controlled line by line with a scanning signal input to the scanning lines, and
wherein a fluctuation range of the drive frequency of the scanning lines in the first display region differs from a fluctuation range of the drive frequency of the scanning lines in the second display region.

6: The control unit according to claim 1, wherein the drive frequency fluctuates at a predetermined fluctuation period Ts, and
a value obtained by multiplying one-half the fluctuation period Ts by N (N is a natural number) is a scanning period Tv of all the scanning lines.

7: The control unit according to claim 1, wherein the gradation correction portion acquires a signal for controlling the drive frequency of the pixels, uses the signal to decide a time period during which the drive frequency is higher than that before and after the time period and/or a time period during which the drive frequency is lower than that before and after the time period, and determines the correction values for the gradation values of each of the pixels indicated by the display signal for each time period thus decided.

8: The control unit according to claim 7, wherein the display device has scanning lines provided for each line of the pixels that are arranged in a matrix, and the drive frequency of the pixels is controlled line by line with a scanning signal input to the scanning lines, and
wherein the gradation correction portion acquires the scanning signal as a signal for controlling the drive frequency of the pixels, and determines the correction values for the gradation values of the pixels line by line in accordance with the drive frequency for each line.

9: The control unit according to claim 7, wherein the gradation correction portion determines the correction values by performing an operation or referring to correction data that has been previously stored and indicates an amount of correction for the gradation values.

10: A display device comprising the control unit according to claim 1.

11: A control method for controlling a display signal indicating gradation of a plurality of pixels in a display device,
the method comprising:
determining correction values for gradation values of each of the pixels indicated by the display signal in accordance with a drive frequency of the pixels.
